(19) United States
(12) Patent Application Publication
(10) Pub. No.: US 2005/0266176 A1
(43) Pub. Date: Dec. 1, 2005

(54) Anti-reflective structure, anti-reflective film having the same, light guide, illumination device, and liquid crystal display device

(75) Inventors: Yoshihiko Ishitaka, Fukushima-ken (JP); Tetsuya Fukuda, Fukushima-ken (JP); Katuhiko Oshita, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/136,578

(22) Filed: May 23, 2005

(30) Foreign Application Priority Data
May 27, 2004 (JP) 2004-157891

(51) Int. Cl. C09K 19/00

(52) U.S. Cl. 428/1.1

(57) ABSTRACT

An anti-reflective structure has multiple micro holes, each hole having an opening at a first surface and a bottom surface facing a second surface opposite to the first surface and each hole extending from the opening to the bottom surface, and convex portions provided on the first surface between adjacent micro holes. The openings are disposed in a staggered arrangement in the first surface. An inner wall surface of each hole has a shape concaved toward the second surface from an inclined which includes a straight line which connects a vertex of the corresponding hole to an apex of each of the convex portions adjacent to the corresponding hole.

### BACKGROUND OF THE INVENTION

1. Field of the Invention

The present invention relates to an anti-reflective structure, which is used in an illumination device for illuminating a liquid crystal display unit or the like, an anti-reflective film having the same, a light guide, an illumination device, and a liquid crystal display device.

2. Description of the Related Art

Conventionally, a light guide plate including an anti-reflective film or a liquid crystal display device in which the light guide plate is used as a front light is known. With the anti-reflective film, external light or illumination light of an illumination device provided on the surface of a liquid crystal display unit is prevented from being reflected before reaching the liquid crystal display unit. Thus, the anti-reflective film is advantageous for effective incidence of external light or illumination light on the liquid crystal display unit, thereby enhancing visibility of the liquid crystal display device. As an example of this type of anti-reflective structure, an anti-reflective film having multiple micro pyramid-shaped protrusions referred to as an anti-reflective (AR) lattice formed on its surface is known. The AR lattice can prevent external light or illumination light from being reflected before incidence on the liquid crystal display unit (for example, see Japanese Unexamined Patent Application Publication No. 2003-279705).

Although, the conventional anti-reflective structure has the micro pyramid-shaped protrusions are formed on its surface, a new anti-reflective structure aimed at an excellent anti-reflective effect is being studied by a different approach. There is also demand for an anti-reflective structure having a proper anti-reflective ability according to various uses.

### SUMMARY OF THE INVENTION

The present invention has been made in consideration of the above-described problems, and it is an object of the invention to provide an anti-reflective structure, which can prevent a reflection of external light or illumination light to significantly enhance visibility of a display portion with external light or illumination light, an anti-reflective film having the anti-reflective structure, a light guide, and a liquid crystal display device.

In order to achieve the above-described object, according to an aspect of the invention, an anti-reflective structure has micro holes, each having an opening at a first surface and a bottom surface facing a second surface opposite to the first surface and each hole extending from the opening to the bottom surface, and convex portions provided on the first surface between adjacent micro holes. The openings are disposed in a staggered arrangement in the first surface. An inner wall surface of each hole has a shape concaved toward the second surface from an inclined surface including a straight line which connects a vertex of the corresponding hole and an apex of each of the convex portions adjacent to the corresponding hole.

According to such an anti-reflective structure, discontinuity at the interface between the structural material and air can be relieved by the multiple micro holes to effectively prevent light reflection in a predetermined direction. Further, since the anti-reflective structure has only the micro holes formed along the first surface, the anti-reflective structure can be efficiently manufactured at low cost. In addition, the anti-reflective structure of the invention has the multiple holes formed over the first surface without protrusions from the first surface. Thus, even though pressure is applied to a region where the anti-reflective structure is formed, the possibility of a decrease in anti-reflective ability can be avoided, thereby obtaining ease to handle.

Further, if the openings are disposed in a staggered arrangement, the holes can be formed with the highest density in the first surface. The anti-reflective ability can be significantly enhanced by increasing the formation density of the holes.

Further, the inner-wall surface of each hole has the shape concaved toward the second surface from the inclined shape including the straight line which connects the vertex of the corresponding hole to the apex of each of the convex portions adjacent to the corresponding hole. Therefore, it is effective to significantly reduce the reflectance of light in a vicinity of a wavelength of 550 nm at which high visual sensitivity is obtained. Further, an absolute reflectance can be made small, thereby enhancing the anti-reflective effect. In addition, when a light guide of an illumination device which is provided on the observation side of a liquid crystal display unit has the anti-reflective structure of the invention, external light or illumination light is emitted to an air space through the anti-reflective structure provided on the light guide. Then, when the inner wall surface of each hole has the shape concaved toward the second surface from the inclined surface including the straight line, contrast can be enhanced.

The formation pitch of the corresponding hole may be in a range of from 200 to 250 nm. Thus, when being emitted from the first surface to an outside after passing through the anti-reflective structure, light can be prevented from leaking in an inclined direction, such that light emitted from the first surface can be enhanced. When the light guide of the illumination device provided on the observation side of the liquid crystal display unit has the anti-reflective structure having such a range of the formation pitch of the hole, display coloring can be reduced when the liquid crystal display device is observed from the inclined direction.

The depth of the corresponding hole may be in a range of from 130 nm to 230 nm. Thus, when the light guide of the illumination device provided on the observation side of the liquid crystal display unit (when light is guided through the light guide, like a front light and proceeds to the outside (air space) from the anti-reflective structure provided in one surface of the light guide), a wavelength of minimum reflectance can be in a range of from 500 nm to 650 nm. It is effective to significantly reduce the reflectance of light in the vicinity of the wavelength of 550 nm at which high visual sensitivity is obtained. In addition, if transmitted light is symmetric (incident light from the first surface or the second surface is emitted from the second surface or the first surface), the wavelength of the minimum reflectance can be in a range of 550±50 nm. Then, it is possible to significantly reduce the reflectance of light in the vicinity of the wavelength of 550 nm at which high visual sensitivity is obtained.

Further, it is preferable that the apex of each convex portion has a quadratic surface whose curvature radius is equal to or less than 30 nm. When the apex of the convex portion has the quadratic surface without a flat surface, incident light is not strongly reflected in one direction, thereby significantly enhancing the anti-reflective ability of the anti-reflective structure. When the curvature radius of the quadratic surface of the apex falls within the range, an absolute reflectance can be reduced, thereby enhancing the anti-reflective effect.

Further, the bottom surface of the hole may be formed in a quadratic surface. When the bottom surface of the hole is formed in the quadratic surface without a flat surface, incident light is not strongly reflected in one direction, thereby significantly advancing the anti-reflective ability of the anti-reflective structure.

Further, according to another aspect of the invention, an anti-reflective film includes the anti-reflective structure of the invention having any one of the above-described configurations on at least one of a front surface and a rear surface thereof. In accordance with another aspect of the invention, an anti-reflective property can be easily be imparted to a light guide or a display device by simply attaching the anti-reflective film to the surface of the light guide or the display device.

According to still another aspect of the invention, a light guide includes the anti-reflective structure of the invention having any one of the above-described configurations and a reflective structure that has multiple micro grooves formed along the second surface of the anti-reflective structure.

In the light guide, refractive index discontinuity is can be relieved by the multiple micro holes to effectively prevent light reflection in the predetermined direction. Since the light guide has the reflective structure and the anti-reflective structure integrally formed thereto, the number of the component members can be decreased when the light guide is applied to a front light or the like.

When the light guide is applied to an illumination device, an illumination device capable of preventing surface reflection can be realized. The illumination device may be combined with a liquid crystal display unit to form a liquid crystal display device. If the illumination device is applied to a liquid crystal display device, the liquid crystal display device has decreased surface reflection, a liquid crystal display device, and thus which high contrast and excellent visibility can be provided.

### BRIEF DESCRIPTION OF THE DRAWINGS

FIG. 1 is a cross-sectional view showing a liquid crystal display device including an illumination device to which an anti-reflective structure of the invention is applied;

FIG. 2 is an enlarged cross-sectional view showing an anti-reflective film having the anti-reflective structure of the invention;

FIG. 3 is an enlarged perspective view showing a reflective layer;

FIG. 4 is a graph showing a verification result of the anti-reflective structure of the invention;

FIG. 5 is a graph showing a verification result of the anti-reflective structure of the invention;

FIG. 6 is a graph showing a verification result of the anti-reflective structure of the invention;

FIG. 7 is a graph showing a verification result of the anti-reflective structure of the invention; and

FIG. 8 is a graph showing a relationship between a depth of a hole of an anti-reflective film and a wavelength of minimum reflectance of to the invention.

### DESCRIPTION OF THE PREFERRED EMBODIMENT

Hereinafter, an embodiment of the invention will be described with reference to the drawings.

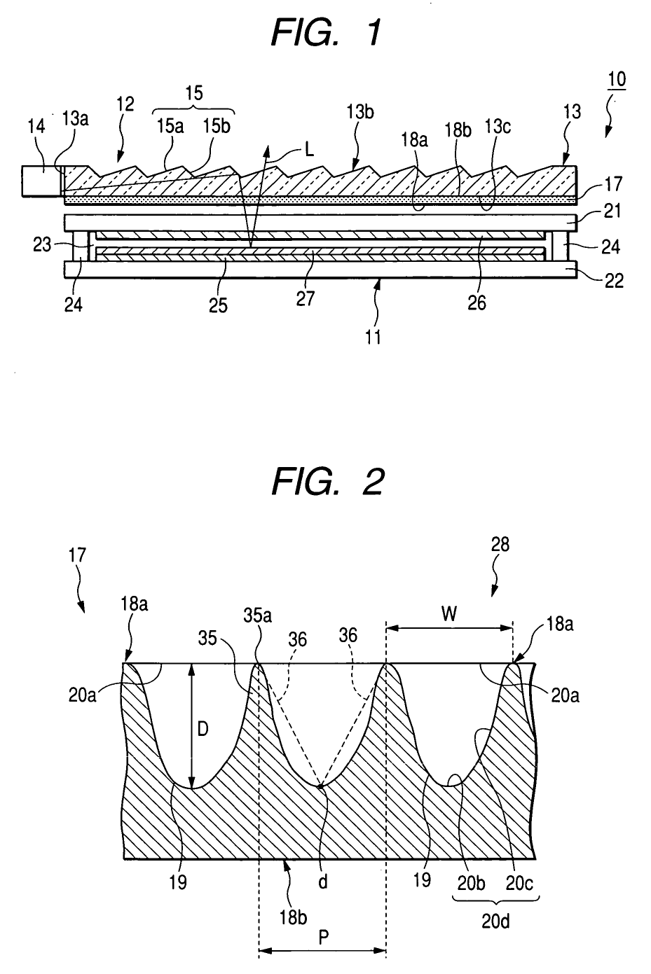

FIG. 1 is a cross-sectional view showing of a liquid crystal display device including an illumination device to which an anti-reflective structure according to an embodiment of the invention is applied. The liquid crystal display device 10 includes a reflective liquid crystal display unit 11 and a front light (an illumination device) 12 disposed on the front surface (the upper surface) of the liquid crystal display unit 11.

The front light 12 functions as an illumination device according to an embodiment of the invention and includes a light guide plate (light guide) 13 and a light source 14, as shown in FIG. 1. The light guide plate (light guide) 13 is a substantially plate-shaped transparent member made of, for example, acryl-based resin or polycarbonate-based resin. The light guide plate 13 includes an incidence surface 13a on which light of the light source is incident, and an observation surface 13b through which the liquid crystal display unit 11 is observed from the outside. The observation surface 13b has multiple micro wedge-shaped triangular grooves 15 which are formed for changing the direction of incident from the light source 14. Further, the bottom surface (the surface facing the liquid crystal display device 10) of the light guide plate 13 functions as an emission surface 13c through which illumination light is emitted.

Each of the wedge-shaped grooves 15 formed in the observation surface 13b has a pair of inclined surfaces. One of the inclined surfaces of each groove 15 is a gently inclined surface 15a and the other is a reflective surface (steeply inclined surface) 15b formed at a greater inclination angle than that of the gently inclined surface 15a. That is, in the observation surface 13b, the gently inclined surface 15a and the reflective surface 15b are alternately formed. Moreover, the shape of the observation surface 13b is not limited to the above-described shape, and any shape may be used as long as light incident from the incidence surface 13a and propagated through the light guide plate 13 can be uniformly guided onto the emission surface 13c. In the present embodiment, the multiple grooves 15 formed in the observation surface 13b function as the reflective structure.

An anti-reflective film 17 having an anti-reflective structure 28 of the invention is attached to the emission surface 13c of the light guide plate 13.

FIG. 2 is an enlarged cross-sectional view of the anti-reflective film 17. The anti-reflective film 17 includes the anti-reflective structure 28 having multiple micro holes 19 extending from a first surface functioning as a reference surface 18a in a thicknesswise direction of the anti-reflective film 17. Each of the holes 19 has an opening 20a exposed in the reference surface 18a, a peripheral wall 20c continued from the opening 20a, and a bottom surface 20b formed near a second surface, which is opposite to the first surface, functioning as an attachment surface 18b. An inner wall surface 20d of each of the holes 19 includes the peripheral wall 20c and the bottom surface 20b. The anti-reflective film 17 is attached to the emission surface 13c of the light guide plate 13 with the attachment surface 18b turned upward. Although FIG. 2 shows the anti-reflective film 17 with the reference surface 18a facing upward, the reference surface 18a faces downward during attachment.

It is preferable that the ratio of the opening 20a to the whole of the reference surface 18a is as larger than that of a connecting portion (a portion of the reference surface 18a excepting the openings 20a) for connecting the peripheries of the adjacent openings 20a together as possible. The reflectance increases as the ratio of the connecting portion increases. Thus, an apex 35a (tip) of a convex portion 35 between the adjacent micro holes may have a steep shape.

In addition, in order to form as many holes 19 as possible in the anti-reflective film 17, the holes 19 may be disposed in a staggered arrangement on the reference surface 18a. When the holes 19 are disposed in the staggered arrangement, the holes 19 can be formed with the highest density in the anti-reflective film 17.

In a shape having a hole pitch of about a half or less of the wavelength, the more the refractive index spatial distribution formed by the connecting portion (or the apex 35a of the convex portion) and air becomes continuous, the more the reflection of light incident on the reference surface 18a of the anti-reflective film 17 is suppressed. Therefore, an anti-reflective function of the anti-reflective film 16 can be maximized by increasing the ratio of the openings 20a while suppressing the ratio the connecting portion (or the apex 35a of the convex portion), which reflects light, to the reference surface 18a.

The inner wall surface 20d of each hole 19 has a shape concaved toward the second surface from an inclined surface 36 (shown in a dotted line in FIG. 2) including a straight line which connects a vertex d of the corresponding hole to the apex of the convex portion 35 adjacent to the corresponding hole 19. As such, since the inner wall surface 20d has the shape concaved toward the second surface from the inclined surface 36, it is effective to significantly reduce the reflectance of light in a vicinity of a wavelength of 550 nm at which high visual sensitivity is obtained. Further, an absolute reflectance can be made small, thereby enhancing an anti-reflective effect. In addition, the contrast of the liquid crystal display device can be enhanced.

The apex 35a of the convex portion 35 is preferably formed in a quadratic surface. The curvature radius of the quadratic surface is preferably equal to or less than 30 nm, more preferably, in a range of from 0 nm to 30 nm, and still more preferably, in a range of from 0 nm to 10 nm. The apex 35a of the convex portion 35 has a quadratic surface without a flat surface, and thus incident light is not strongly reflected in one direction, thereby significantly enhancing an anti-reflective ability of the anti-reflective structure. If the curvature radius of the quadratic surface of the apex 35a exceeds 30 nm, the absolute reflectance becomes large, which causes a decrease in anti-reflective effect.

The bottom surface 20b of each hole 19 is preferably formed in a quadratic surface having a continuously curved surface. If the bottom surface 20b of each hole 19 has a flat portion, the anti-reflective function deteriorates due to a refraction index discontinuity at the interface between a structural material and air. When the bottom surfaces 20b are formed in the quadratic surfaces, the refractive index spatial distribution formed by the structural material and air continuously changes, so that the reflectance can be made small. In addition, preferably, the maximum diameter W of the opening 20a of each hole 19 having a circular shape is as small as possible and has a size in a predetermined range. With the openings 20a each having the large maximum diameter W, reflected and diffracted light occurs to produce colored reflected light. The occurrence of the reflected and diffracted light can be prevented by decreasing the maximum diameter W of the opening 20a to enhance the anti-reflective function. With the openings 20a each having the large maximum diameter W, shape reproducibility of the anti-reflective film 17 at the time of formation possibly deteriorates, while with the openings 20a each having the small maximum diameter W, an anti-reflective property possibly deteriorates.

In order to decrease the connecting portion, the formation pitch P of each hole 19 is preferably decreased as much as possible. When the connecting portion, which reflects light, is decreased to permit the holes 19 to be closely formed, the anti-reflective function of the anti-reflective film 17 can be maximized.

The formation pitch of each hole 19 is preferably equal to or less than 250 nm, more preferably, in a range of from 0 nm to 200 nm, and still more preferably, in a range of from 0 nm to 150 nm. If the formation pitch of each hole 19 exceeds 250 nm, the tone of emitted light appears to be colored due to the spectroscopic function of diffracted light. Further, when light passing through the anti-reflective structure portion is emitted from the first surface to the outside, light easily leaks in the inclined direction, which causes a decrease in luminance of light emitted from the first surface.

If the depth D of the hole 19 is set in a range of from 130 nm to 230 nm, the wavelength of the minimum reflectance is preferably set in a range of from 500 nm to 650 nm, more preferably, in a range of from 150 nm to 210 nm, and still more preferably, in a range of from 170 nm to 200 nm.

Although the depth D of each hole 19 is preferably as deep as possible, with the excessively deep hole 19, the shape reproducibility of the holes 19 deteriorates at the time of the formation of the anti-reflective film 17. The bottom surface 20b of each hole 19 preferably has little flat portion. If the depth D of the hole 19 is less than 130 nm, it is not effective to reduce the reflectance of light in the vicinity of the wavelength 550 nm at which the high visual sensitivity is obtained.

The reflectance of the anti-reflective film 17 having such a configuration is suppressed to, for example, 1% or less. The anti-reflective film 17 may be formed by injection molding using a mold having protrusions formed on the inner surface for patterning the holes 19. As a material for forming the anti-reflective film 17, silicon-based resin having high transmittance may be used.

Returning to FIG. 1, the light source 14 is disposed adjacent to the incidence surface 13a of the light guide plate 13. The light source 14 is, for example, a rod-shaped light source provided along the incidence surface 13a of the light guide plate 13. For example, the light source 14 may include a light emitting element such as a white LED (Light Emitting Diode) or the like provided at one or both ends of a rod-shaped light guide. Moreover, any light source 14 may be used without a problem as long as light can be incident on the incidence surface 13a of the light guide plate 13. For example, a plurality of light emitting elements such as LEDs or the like may be disposed along the incidence surface 13a of the light guide plate 13.

The liquid crystal display unit 11 constituting the liquid crystal display device 10 includes a liquid crystal layer 23 interposed between an upper substrate 21 and a lower substrate 22 facing each other. Further, the liquid crystal layer 23 is sealed by a sealing material 24 provided in a frame shape along the inner peripheries of the substrates 21 and 22. On the inner surface (the lower substrate 22 side) of the upper substrate 21, a liquid crystal control layer 26 is formed. On the inner surface of the lower substrate 22 (the upper substrate 21 side), a reflective layer 25 containing a metal thin film is formed to reflect illumination light from the front light 12 or external light. On the surface of the reflective layer 25, a liquid crystal control layer 27 is formed.

The liquid crystal control layers 26 and 27 include an electrode for controlling a drive of the liquid crystal layer 23, an alignment film, a semiconductor element for switching the electrode, and the like. Further, the liquid crystal control layers 26 and 27 may include a color filter.

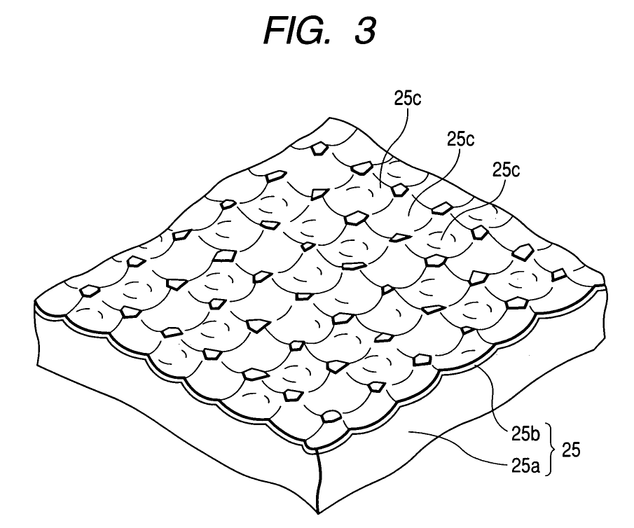

The liquid crystal display unit 11 shown in FIG. 1 is reflective type in which illumination light incident from the front light 12 or external light incident from the outside is reflected by the reflective layer 25 to perform a display. As shown in FIG. 3, for example, the reflective layer 25 is formed by depositing a reflective film 25a on an organic film 25a made of acrylic resin or the like having irregularities formed in its surface. The reflective film 25b preferably includes a high-reflectance metal thin film of aluminum, silver, or the like. Further, on the surface of the reflective film 25b, a planarizing film of silicon-based resin is formed for planarizing the surface irregularities.

A concave portion 25c may be formed in a smooth curved surface such as a spherical surface, a combination of the curved surface and a flat surface, or the like. The inclination angle of the inner surface or the pitch and depth of the concave portion are controlled, such that the reflective layer can have appropriate reflection properties suitable for the design of an electronic apparatus including the liquid crystal display device 10 as a display unit. The reflective layer 25 is advantageous for efficient reflection of incident light, thereby permitting a high-luminance display. Further, the reflective layer can prevent regular reflection of external light used as incident light to realize a bright display having excellent visibility.

The operation of the invention having the above-described configuration will be described with reference to FIG. 1, laying emphasis on the anti-reflective film. When the light source 14 is lighted for illuminating the liquid crystal display unit 11, light illuminated from the light source 14 is introduced into the light guide plate 13 through the incidence surface 13a of the light guide plate 13. Light is propagated through the light guide plate 13 and reaches the reflective surface 15b to change an optical path of light propagated through the light guide plate 13, and then light is uniformly guided to the emission surface 13c. Light emitted from the emission surface 13c is incident on the anti-reflective film 17 through the attachment surface 18b in contact with the emission surface 13c. As described above, the anti-reflective film 17 has the multiple holes 19 formed in the reference surface 18a and the convex portions 35 provided on the first surface between the adjacent holes. The openings 20a of the respective holes 19 are disposed in the staggered arrangement along the first surface 18a. The inner wall surface 20d of each hole 19 has the shape concaved toward the second surface from the inclined surface 36 including the straight line which connects the vertex d of the hole to the apex of the concave portion adjacent to the corresponding hole 19. Thus, light incident on the anti-reflective film 17 is little reflected by the reference surface 18a. Further, light incident on the anti-reflective film 17 is not strongly reflected in the predetermined direction because the anti-reflective film 17 has the holes 19 each having a smooth quadratic surface. As such, the light incident on the anti-reflective film 17 is efficiently incident on the liquid crystal display unit 11. Light incident on the liquid crystal display unit 11 is reflected by the reflective layer 25 and emitted as projection light of a character or image displayed on the liquid crystal display unit 11 from the liquid crystal display unit 11.

Light emitted from the liquid crystal display unit 11 is incident on the anti-reflective film 17 from the reference surface 18a of the anti-reflective film 17. Light incident on the anti-reflective film 17 is efficiently introduced into the light guide plate 13 (see an arrow L in FIG. 1). Therefore, the quantity of light reflected again by the surface of the anti-reflective film 17 and returned to the liquid crystal display unit 11 can be significantly decreased. The reflectance of the anti-reflective film 17 is suppressed to, for example, 1% or less. An observer can observe sharp and bright projection light of a character or image displayed on the liquid crystal display unit 11 through the light guide plate 13.

As such, the anti-reflective film 17 has the multiple holes 19 formed in the reference surface 18a in order to extremely decrease the connecting surface (the portion of the reference surface 18a excepting the openings 20a). Thus, light from the liquid crystal display unit 11 can be mostly transmitted without being reflected by the surface, thereby significantly enhancing the visibility of the liquid crystal display unit 11. Further, even when the quantity of light emitted from the light source 14 is decreased to some extent, the liquid crystal display unit 11 can be efficiently illuminated to contribute to saving of a battery.

Further, the anti-reflective film 17 has the anti-reflective effect on light incident from the attachment surface 18b. That is, the bottom surface 20b of each hole 19 has the quadratic surface with substantially no flat surface, and thus light incident on the rear side of the bottom surface 20b can be prevented from being reflected in one direction. Therefore, light incident on the anti-reflective film 17 from the light guide plate 13 is efficiently emitted from the reference surface 18a without being reflected to the inside of the anti-reflective film 17 by the reference surface 18a, thereby permitting bright illumination of the liquid crystal display unit 11.

Moreover, in the above embodiment, it is described that the anti-reflective film 17 is provided separately from the light guide plate (light guide) 13. However, the anti-reflective function may be imparted to the light guide. In this case, for example, there may be provided an anti-reflective structure including multiple micro holes, each having an opening along the emission surface 13c of the light guide plate 13 and a bottom surface facing an observation surface opposite to the emission surface 13c, and extending from the opening toward the bottom surface, and convex portions provided on the emission surface. The openings are disposed in the staggered arrangement. The inner has the shape concaved toward the observation surface from the inclined surface including the straight line which connects the vertex of the corresponding hole to the apex of the concave portion adjacent to the corresponding hole. In this case, the emission surface 13c functions as the first surface of the anti-reflective structure and the observation surface 13b functions as the second surface thereof.

In order to confirm the properties of the anti-reflective structure of the invention, verification was performed. In the verification, anti-reflective films including three types of anti-reflective structures were prepared by changing the hole pitch in three steps. That is, three types of anti-reflective films having hole pitches of 200 nm, 220 nm, and 250 nm, respectively, were prepared. As the material for the anti-reflective films, silicone resin was used, and the holes were formed in the staggered arrangement. As a result of AFM (Atomic Force Microscopy) measurement of the surface shape of each of the three types of the anti-reflective films, it was confirmed that the holes were uniformly formed in the staggered arrangement on the reference surfaces of the anti-reflective films with the pitches of 200 nm, 220 nm, and 250 nm, respectively.

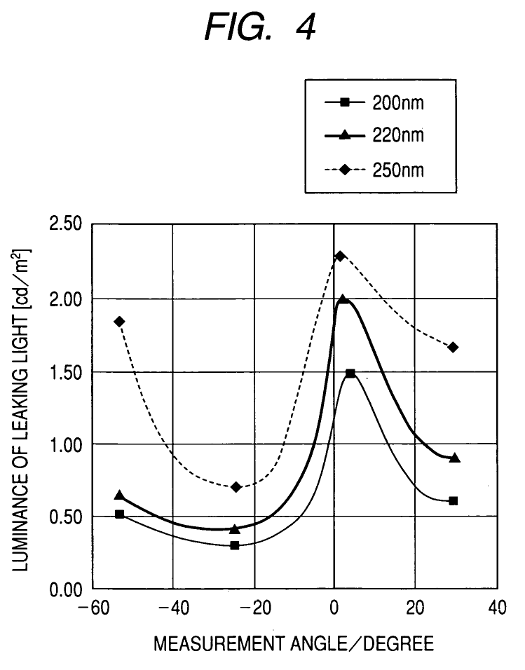

First, the surface (the surface having the openings of the holes) of each of the three anti-reflective films was irradiated with white light from a white light LED light source, and leakage light from the surface of each anti-reflective film was measured. Leakage light was measured by moving a detector for detecting leakage light within a range of from −50° to 50° on the assumption that a direction normal to the anti-reflective film was 0°, and inclination angles to opposite sides from the normal direction were the minus side and plus side, respectively. The results of measurement are shown in a graph of FIG. 4. The graph of FIG. 4 shows the angle of the detector as the abscissa and the luminance (cd/m²) of leakage light as the ordinate.

FIG. 4 indicates that, with any one of the angles, leakage light decreases as the hole pitch decreases. Particularly, it is confirmed that, with the anti-reflective film having the hole pitch of 200 nm, the maximum luminance is about 1.50 cd/m² near the angle of 0° where leakage light becomes maximum, and thus the excellent anti-reflective effect is obtained. This suggests that excellent display quality such as high contrast and high luminance can be obtained when an anti-reflective film having a sufficiently small hole pitch is applied to a liquid crystal display device or the like.

Next, in order to verify the relationship between the opening diameter of the hole and leakage chromaticity of an anti-reflective film having the anti-reflective structure of the invention and find an optimum opening diameter of the hole, three types of anti-reflective films were prepared by changing the hole diameter in three steps. That is, the three types of anti-reflective films having hole opening diameters of 250 nm, 300 nm, and 400 nm, respectively, were prepared. As the material for the anti-reflective films, silicone resin was used, and the holes were disposed in the staggered arrangement.

As a result of AFM (Atomic Force Microscopy) measurement of the surface shape of each of the three types of anti-reflective films, it was confirmed that the holes were uniformly formed in the staggered arrangement on the reference surfaces of the anti-reflective films with the opening diameters of 250 nm, 300 nm, and 500 nm, respectively. Further, the conventional anti-reflective film including the AR lattice having an irregular surface formed by evaporation was prepared as a comparative example.

In measurement, each of the anti-reflective films having the three opening diameters was attached to the light guide plate made of transparent resin, and the light guide plate was irradiated with white light from the white LED light source to measure a leakage chromaticity at the surface of each anti-reflective film. Further, the conventional anti-reflective film including the AR lattice having the irregular surface was attached to the light guide plate made of transparent resin, and the light guide plate was irradiated with white light from the white LED light source to measure a leakage chromaticity at the surface of the conventional anti-reflective film.

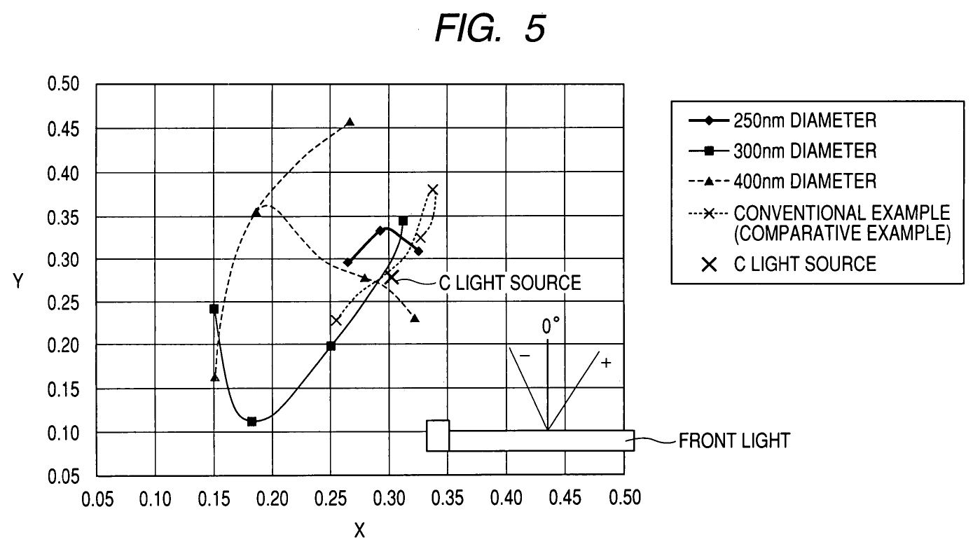

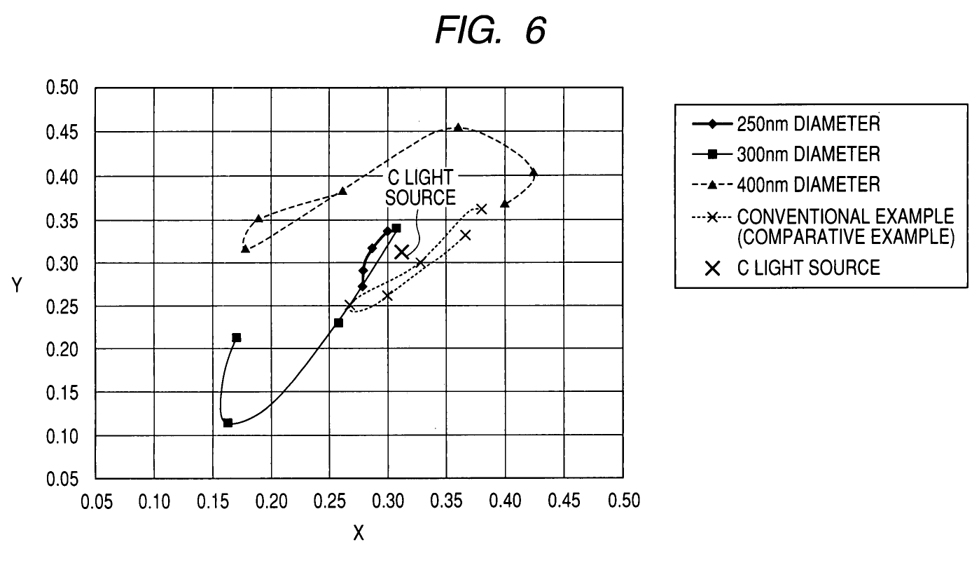

Leakage light was measured by moving the detector for detecting leakage light within a range of −300 to 300 on the assumption that a direction normal to the light guide plate was 0°, and inclination angles to opposite sides from the normal direction were the minus side and plus side, respectively. The results of measurement are shown in FIG. 5. Leakage light was also measured by moving the detector for detecting leakage light within a range of −30° to 30° on the assumption that a direction parallel to the light guide plate was 0°, and inclination angles to opposite sides from the normal direction were the minus side and plus side, respectively. The results of measurement are shown in FIG. 6. Each of FIGS. 5 and 6 is an xy chromaticity diagram in which a C light source (white) is marked with x.

FIGS. 5 and 6 indicate that the dependency of chromaticity on the angle decreases as the hole opening diameter of the anti-reflective film decreases, and the chromaticity values are concentrated near the C light source. It was also found that, in the anti-reflective film having a hole opening diameter of 250 nm, the chromaticity values are concentrated near the C light source without greatly deviating from the C light source. This suggests that, by applying an anti-reflective film having such a small hole opening diameter to the front light of the liquid crystal display device, no coloring is observed in the display even when the liquid crystal panel is observed in an oblique direction, and the liquid crystal panel has high display color reproducibility. Further, since the chromaticity distribution and coloring decrease as the formation pitch of each hole deceases, an anti-reflective film with a smaller hole pitch may be excellent in color reproducibility.

Furthermore, it was found that the anti-reflective films having the hole opening diameters of 300 nm and 400 nm, respectively, have large dependency of chromaticity on the angle, and the chromaticity values greatly deviate from the C light source. This suggests that, with a hole opening diameter of 300 nm or more, significant coloring is observed in the display of the liquid panel when the anti-reflective film is applied to the front light of the liquid crystal display device, and the liquid crystal panel has low color reproducibility. It was also found that the conventional anti-reflective film including the AR lattice having the irregular surface formed by evaporation has high dependency of chromaticity on the angle, and shows a deviation from the C light source, as compared to the anti-reflective film of the invention having the hole opening diameter of 250 nm. It was thus confirmed that the anti-reflective film of the invention having the hole opening diameter of the small value has excellent color reproducibility, as compared to the conventional anti-reflective film having the AR lattice.

Furthermore, in order to verify the relationship between a curvature radius of the apex of the convex portion provided between the holes of the anti-reflective structure and the reflectance and find an optimum curvature radius of the apex, five types of anti-reflective films were prepared by changing the curvature radius of the apex in five steps. That is, the five types of anti-reflective films having curvature radiuses of 10 nm, 18 nm, 30 nm, 40 nm, and 50 nm, respectively, were prepared. As the material for the anti-reflective films, silicone resin was used, and the holes were disposed in the staggered arrangement.

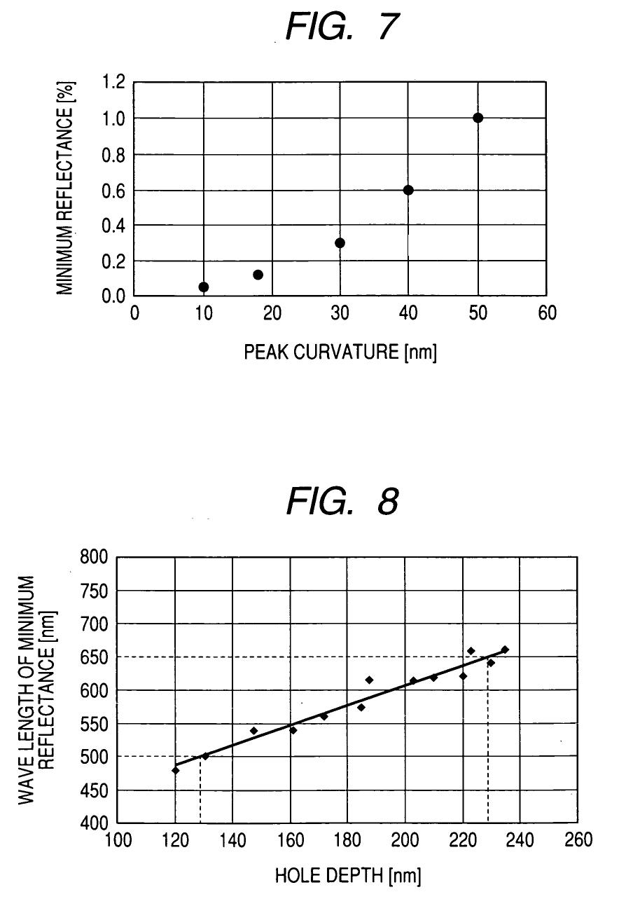

The surface (the surface having the openings of the holes formed therein) of each of the five types of anti-reflective films having the different curvature radiuses of the apexes of the convex portions was irradiated with light at wavelengths changing from 400 to 700 nm to measure the minimum reflectance (%) at the surface of each anti-reflective film. FIG. 7 shows the curvature radius of the apex and the minimum reflectance of each of the five types of anti-reflective films.

It was confirmed from the result shown in FIG. 7 that an anti-reflective film capable of setting the minimum reflectance of 3% or less which sufficiently exhibits the anti-reflective effect has the curvature radius of the apex of 30 nm or less. It was also confirmed that, when the curvature radius of the apex is 10 nm, the minimum reflectance can be set to 0.05%, thereby significantly enhancing the anti-reflective effect.

Furthermore, in order to verify the relationship between the reflectance and the hole depth of the anti-reflective structure and find an optimum hole depth, thirteen types of anti-reflective films were prepared by changing the hole depth within a range of from 120 nm to 230 nm in thirteen steps. That is, the thirteen types of anti-reflective films having the hole depths of 120 nm, 130 nm, 147 nm, 161 nm, 172 nm, 185 nm, 188 nm, 203 nm, 210 nm, 220 nm, 223 nm, 230 nm, and 235 nm, respectively, were used. As the material for the anti-reflective films, silicon-based resin was used, and the holes were disposed in the staggered arrangement.

The surface (the surface having the openings of the holes formed therein) of each of the thirteen types of anti-reflective films having the different hole depths was irradiated with light at wavelengths changing from 400 to 700 nm to measure a wavelength (nm) exhibiting the minimum reflectance (%) at the surface of each anti-reflective film. FIG. 8 shows the hole depth and the wavelength of the minimum reflectance of each of the thirteen types of anti-reflective films.

When the light guide of the illumination device provided on the observation side of the liquid crystal display unit has the anti-reflective film (when light is guided into the light guide, like the front light and proceeds from the anti-reflective film provided on one surface of the light guide to the outside (air space)), the wavelength of the minimum reflectance is preferably in a range of from 600-100 nm to 600+50 nm (that is, 500 nm to 650 nm). Thus, it was confirmed that the hole depth is in a range of from 130 nm to 230 nm, from the result shown in FIG. 8. Further, when transmitted is symmetric, the wavelength of the minimum reflectance is preferably 550±50 nm. Thus, it is confirmed that the hole depth is in the range of from 130 nm to 200 nm, from the result shown in FIG. 8.

According to the invention, an anti-reflective structure which can prevent the reflection of external light or illumination light to significantly enhance the visibility of the display portion with external light or illumination light, an anti-reflective film having the anti-reflective structure, a light guide, and a liquid crystal display device can be provided.

1. An anti-reflective structure comprising:
multiple micro holes, each having an opening at a first surface and a bottom surface facing a second surface opposite to the first surface and each hole extending from the opening to the bottom surface; and
convex portions provided on the first surface between adjacent micro holes,
wherein the openings are disposed in a staggered arrangement in the first surface, and
an inner wall surface of each hole has a shape concaved toward the second surface from an inclined surface including a straight line which connects a vertex of the corresponding hole to an apex of each of the convex portions adjacent to the corresponding hole.

2. The anti-reflective structure according to claim 1,
wherein a formation pitch of the corresponding hole is in a range of from 200 to 250 nm.

3. The anti-reflective structure according to claim 1,
wherein a depth of the corresponding hole is in a range of from 130 nm to 230 nm.

4. The anti-reflective structure according to claim 1,
wherein a depth of the corresponding hole is in a range of from 130 nm to 200 nm.

5. The anti-reflective structure according to claim 1,
wherein a diameter of the opening of the corresponding hole is equal to or less than 250 nm.

6. The anti-reflective structure according to claim 1,
wherein the apex of each convex portion has a quadratic surface whose curvature radius is equal to or less than 30 nm.

7. An anti-reflective film comprising:
the anti-reflective structure according to claim 1 formed on at least one of a front surface and a rear surface thereof.

8. A light guide comprising:
the anti-reflective structure according to claim 1; and
a reflective structure that has multiple micro grooves formed along the second surface of the anti-reflective structure.

9. An illumination device comprising:
the light guide according to claim 8; and
a light source that irradiates light onto the light guide.

10. A liquid crystal display device comprising:
the illumination device according to claim 9 at an observation side of a liquid crystal display unit.
